(19) United States
(12) Patent Application Publication
(10) Pub. No.: US 2019/0246074 A1
(43) Pub. Date: Aug. 8, 2019

(54) HIGH TEMPERATURE VIDEO CAMERA SYSTEM

(71) Applicant: Honda Motor Co., Ltd., Tokyo (JP)

(72) Inventors: Jared D. Sebree, Franklin, IN (US); James E. Ludovici, Greensburg, IN (US); Bryan A. Mermoud, Shelbyville, IN (US)

(21) Appl. No.: 15/888,281

(22) Filed: Feb. 5, 2018

(51) Int. Cl. H04N 7/18; H04N 5/225

(52) U.S. Cl. CPC H04N 7/183; H04N 5/2256; H04N 5/2252

(57) ABSTRACT

A portable high temperature camera system includes a wireless camera, a housing defining an interior chamber in which the wireless camera is accommodated, and a transparent member affixed to the housing and arranged to allow the wireless camera to capture images therethrough.

### BACKGROUND

It is sometimes necessary or desirable to use cameras for capturing video or pictures in locations that are out of reach or difficult to view under normal circumstances. For example, places of elevated temperature can be difficult for cameras due to the tendency of conventional video/camera equipment shutting down (e.g., at temperatures above 130° F. or 54.4° C.). While some cameras and camera systems are known for handling such elevated temperature operating environments, these tend to be immobile (i.e., not very portable), expensive, complicated, etc.

### BRIEF DESCRIPTION

According to one aspect, a portable high temperature camera system includes a wireless camera, a housing defining an interior chamber in which the wireless camera is accommodated, and a transparent member affixed to the housing and arranged to allow the wireless camera to capture images therethrough.

According to another aspect, a high temperature camera enclosure assembly for a wireless camera includes a housing defining an interior chamber in which the wireless camera is accommodated and a transparent member secured to the housing and arranged to enable the wireless camera to capture images externally relative to the housing.

According to a further aspect, a portable high temperature camera and closure assembly includes a housing having a wireless camera received therein and a transparent member secured to the housing and arranged to enable the wireless camera to capture images externally relative to the housing.

### BRIEF DESCRIPTION OF THE DRAWINGS

FIG. 1 is a perspective view of a portable high temperature camera system having an enclosure assembly with a wireless camera accommodated therein according to an exemplary embodiment.

FIG. 2 is a front elevation view of the camera system of FIG. 1.

FIG. 3 is a side elevation view of the camera system of FIG. 1.

FIG. 4 is a perspective cross-sectional view of the camera system of FIG. 1.

### DETAILED DESCRIPTION

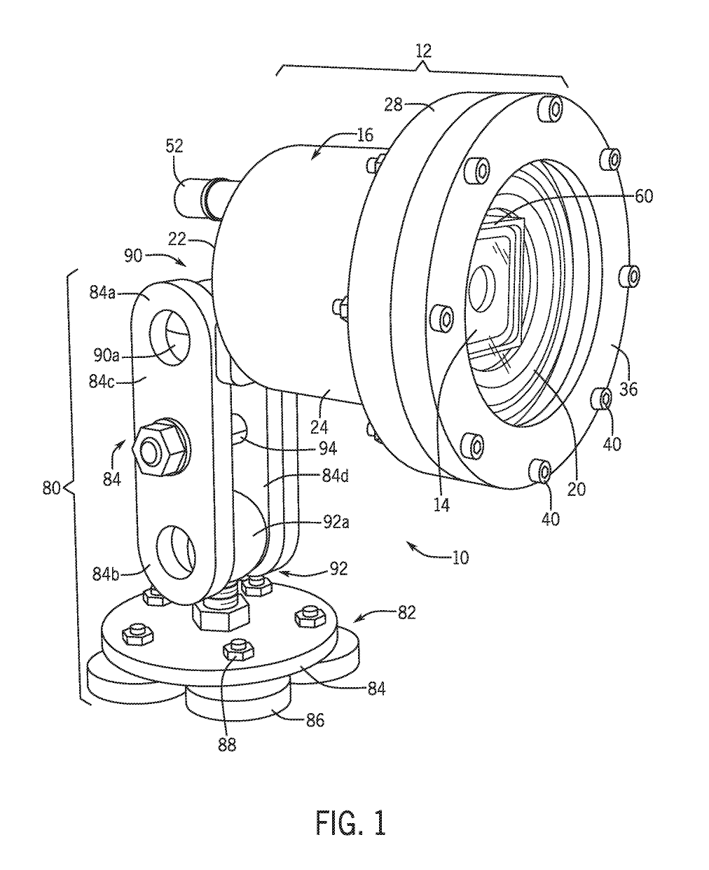

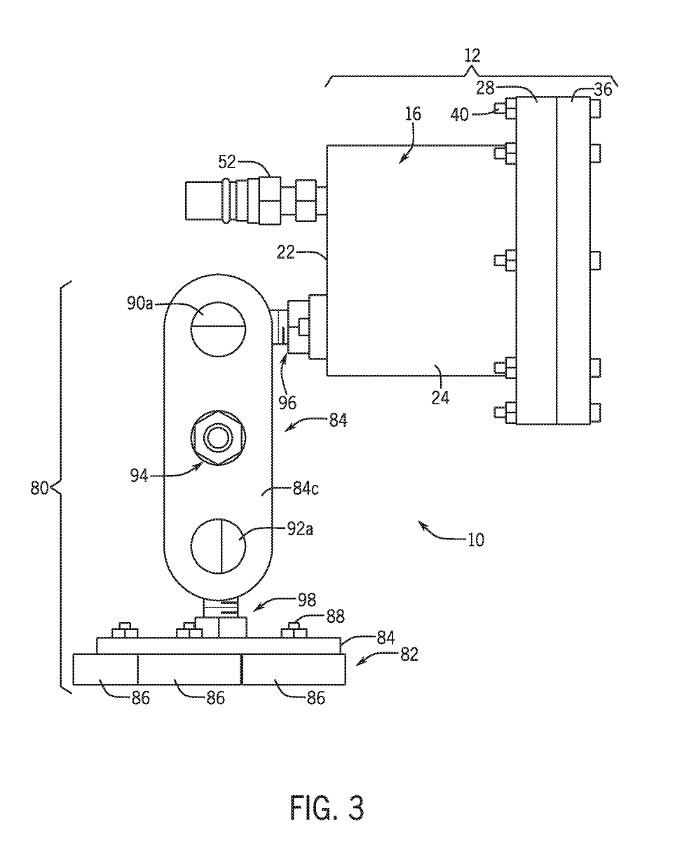

Referring now to the drawings wherein the showings are for purposes of illustrating one or more exemplary embodiments and not for purposes of limiting the same, FIGS. 1-4 illustrates a portable high temperature camera system generally designated by reference numeral 10. The camera system 10 includes a portable high temperature camera enclosure assembly 12 and a wireless camera 14. Thus, the enclosure assembly 12 is provided for the wireless camera 14 and, in one embodiment, is particularly provided for insulating the wireless camera 14 from heat and allowing the same to be used in high temperature environments (e.g., at temperatures above 130° F. or 54.4° C.). In one embodiment, the wireless camera 14 is a high definition video camera, such as a camera sold under the GOPRO brand offered for sale by GoPro, Inc. of San Mateo, Calif., United States. This size of small camera allows the housing 16 to remain relatively small yet still provide high definition video and image capturing capabilities for the camera system 10. Moreover, this type of camera allows use of Wi-Fi to control the wireless camera 14 without compromising the integrity of the enclosure assembly 12.

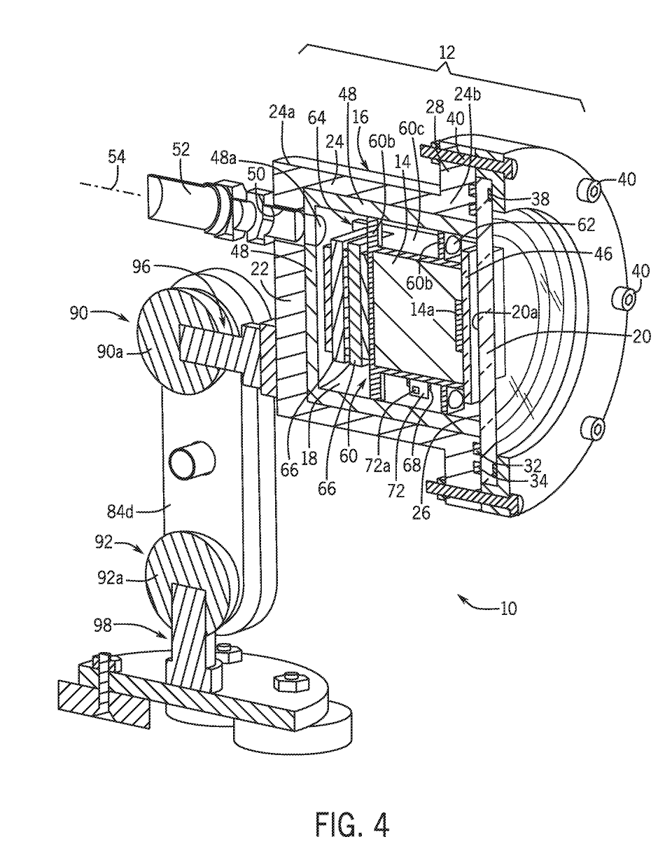

The camera system 10, and particularly the enclosure assembly 12, includes a housing 16 defining an interior chamber 18 (FIG. 4) in which the wireless camera 14 is accommodated and a transparent member 20 affixed or secured to the housing 16 and arranged to allow the wireless camera 14 to capture images therethrough. In particular, as shown in the illustrated embodiment, the housing 16 has the wireless camera 14 received therein with the transparent member 20 arranged to enable the wireless camera 14 to capture images externally relative to the housing 16. In one embodiment, the housing is formed of aluminum, though this is not required. In the same or other embodiments, the transparent member 20 is formed of a quartz material (e.g., a pure quartz material) that provides heat insulation to the wireless camera 14 while allowing the wireless camera 14 to capture images therethrough.

As best shown in FIG. 4, the housing 16 includes a base wall 22 and at least one body wall 24 extending from the base wall 22 to define the interior chamber 18. In the illustrated embodiment, the at least one body wall 24 is a cylindrical shaped wall to provide the housing 16 with a cup-shape. However, it is to be appreciated that other shapes for the housing 16 are contemplated. For example, the at least one body wall could comprise a plurality of walls extending upward from the base wall 22 to form a polyhedron shape with an opening provided for the camera 14. In the illustrated embodiment, the at least one body wall 24, hereinafter referred to as cylindrical wall 24, has a proximal end 24a connected to the base wall 22 and a distal end 24b defining a sight opening 26 (FIG. 4) opposite the base wall 22 and opposite the proximal end 24a.

The housing 16 further includes a flange portion 28 extending outwardly from the at least one body wall 24 at or adjacent the distal end 24b thereof. In the illustrated embodiment, the flange portion 28 is annularly provided at the distal end 24b about the sight opening 26. The transparent member 20 is secured against the flange portion 28 to close the interior chamber 18 with the camera 14 received therein. With specific reference to FIG. 4, at least one inner seal (e.g., seals 30, 32) is interposed between the flange portion 28 and an inner or interior side 20a of the transparent member 20. In particular, in the illustrated embodiment, the at least one seal includes inner O-ring seal 32 and outer O-ring seal 34 interposed between the flange portion 28 and the inner side 20a of the transparent member 20 to seal therebetween.

As shown, a clamp ring 36 can be fixedly secured to the flange portion 28 to thereby affix the transparent member 20 to the housing 16. At least one outer seal (i.e., seal 38) can be interposed between the clamp ring 36 and an outer or exterior side 20b of the transparent member 20. In one embodiment, the at least one outer seal is a polytetrafluoroethylene (PTFE) ring seal, such as sold under the trade name TEFLON® by Chemours of Wilmington, Del., United States. As shown, circumferentially spaced fasteners 40 can be used to secure the clamp ring 36 to the flange portion 28 of the housing 16. In one embodiment, the O-ring seals 32, 34 are high temperature O-rings. In a more specific embodiment, the O-ring seals can be formed of a fluorinated elastomer, such as a perfluoro-elastomer (FFKM).

To further insulate the wireless camera 14 from heat exposure, a hot mirror 46 can be interposed between the wireless camera 14 and the transparent member 20 as best shown in FIG. 4. In particular, the hot mirror 46 is disposed on the interior side 20a of the transparent member 20 for reflecting infrared (IR) wavelengths away from the wireless camera 14 to thereby reflect infrared heat away from the wireless camera 14. In one embodiment, the hot mirror 46 is a dichroic, heat-reflection optic, which filters out heat energy by reflecting infrared light and simultaneously transmitting the visible spectrum. Thus, the hot mirror 46 has a reflective surface facing away from the wireless camera 14 for reflecting infrared heat while enabling the wireless camera 14 to capture images therethrough.

Also to protect the wireless camera 14 from heat, an insulating material 48 can be received within the interior chamber 18 defined by the housing 16 and interposed between the wireless camera 14 and the housing 16 for insulating the wireless camera 14. In one embodiment, the insulating material 48 lines interior walls of the housing 16 that define the interior chamber 18 such that the heat insulating material 48 is interposed between the housing 16 and the wireless camera 14. More particularly, the insulating material 48 can be lined against (e.g., in abutment or contact with) the base wall 22 and the cylindrical wall 24 as best shown in FIG. 4. In one embodiment, the insulating material 48 is formed of an oxidized polyacrylonitrile (OPAN) carbon fiber having very low thermal conductivity.

As shown best in FIG. 4, a vacuum port 50 can be defined through the housing 16, and particularly through the base wall 22 of the housing 16 in the illustrated embodiment, and fluidly connected to the interior chamber 18 to enable a vacuum to be applied to the interior chamber 18 for further heat insulating the wireless camera 14. The insulating material 48 that lines the base wall 22 can include an aperture 48a in registry with the vacuum port 50. A vacuum fitting 52 can be affixed to the housing 16 and arranged within the vacuum port 50. In particular, the vacuum fitting 52 is connectable to an associated vacuum line 54 (shown schematically in FIG. 4) for applying the vacuum to the interior chamber 18. The vacuum fitting 52 is disconnectable from the associated vacuum line 54 for enabling portability of the housing 16 and maintaining the vacuum within the interior chamber 18. In particular, the vacuum line 54 can be connected to a vacuum source (not shown) to apply a vacuum condition to the interior chamber 18 via the vacuum fitting 52 provided or disposed within the vacuum port 50. When the vacuum line 54 is disconnected from the vacuum fitting 52, the vacuum fitting 52 closes to maintain the vacuum condition within the interior chamber 18 of the housing. In one embodiment, the vacuum fitting 52 is a quick release fitting that allows convenient and quick disconnection of the vacuum line 54 from the housing 16 once sufficient vacuum is provided within the interior chamber 18.

The camera system 10 can further include a camera holder 60 disposed within the interior chamber 18 and holding the wireless camera 14 in a suspended position relative to the housing 16 for thermally protecting the wireless camera 14. In particular, the camera holder 60 is disposed within the housing 16 and holds the wireless camera 14 in suspended relation relative to the walls 22, 24 of the housing 16. Thus, the wireless camera 14 is suspended in spaced relation relative to the walls 22, 24 by the camera holder 60. Additionally, in the illustrated embodiment, the camera holder 60 suspends or supports the wireless camera 14 in spaced relation relative to the insulating material 48 lining the walls 22, 24.

In particular, the camera holder 60 can include a main body 60a shaped to complementarily receive the wireless camera 14 therein and the camera holder 60 can include flange projections 60b, 60c extending outwardly from the main body 60a to engage the walls 22, 24 and/or the insulating material 48 lining the walls 22, 24 to thereby suspend the main body 60a and the wireless camera 14 contained therein. The camera holder 60 can include a light support structure or portion that supports at least one light source externally relative to the wireless camera 14. In the illustrated embodiment, forward flange projections 60b of the camera holder 60 are the light support structure or portion that support a plurality of light sources 62 all disposed externally relative to the wireless camera 14.

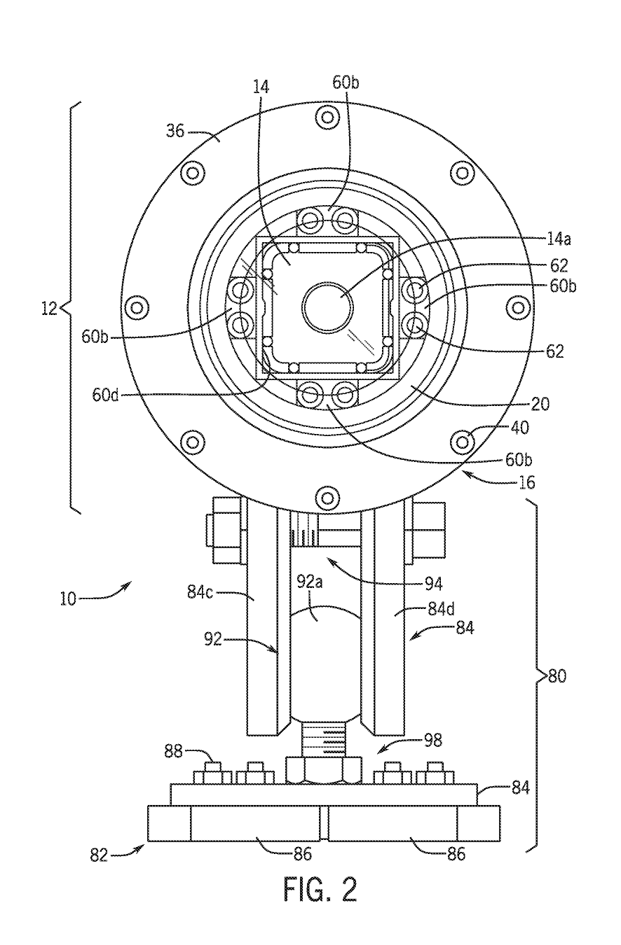

In particular, the light sources 62 are supported by the camera holder 60 and arranged to provide illumination for the wireless camera 14 when capturing images. The light sources 62 can be LED light sources disposed about a perimeter of the wireless camera 14 as best shown in FIG. 2. In particular, in the illustrated embodiment, the light sources 62 are provided in sets of two and each set includes a wide-angle LED and a narrow-angle LED, both provided to emit sufficient light for the camera system 10 to be used effectively in a dark environment.

As shown in the illustrated embodiment, the camera holder 60 includes a forward opening 60d through which lens 14a is aimed for capturing images and/or video. A battery holding structure or portion 64 can hold a battery or batteries 66 external to the wireless camera 14. In particular, in the illustrated embodiment, the battery support structure or portion 64 is integrally formed with the camera holder 60 and provided rearward of the wireless camera 14 as shown in FIG. 4.

Additionally, a circuit holding structure or structure portion 68 can be provided to hold a circuit (schematically illustrated as circuit 72 in FIG. 4) electrically connecting the battery or batteries 66 to the light sources 62. Like the battery support structure or portion 64, the circuit support structure or portion 68 of the illustrated embodiment can be formed integrally with the camera holder. In one embodiment, the battery or batteries 66 are provided as a battery pack of two lithium-polymer (LiPo) batteries mounted behind the wireless camera 14. In particular, the battery support structure or portion 64 can provide slots into which the batteries 66 are mounted, and such slots can be complementarily formed for accommodating the batteries. Thus, the battery support structure (and the camera holder 60) holds the batteries 66 in suspended relation relative to the housing 16 and the insulating material 48 lining the housing while also exposing the battery 66 to the vacuum provided within the interior chamber 18 to thereby maintain the efficiency and capacity of the battery 66. More particularly, the camera holder 60, with the battery support portion 64 and the circuit support portion 68 integrally formed therewith, suspends and maintains the wireless camera 14, the light sources 62, the circuit 72, and the battery or batteries 66 in a central suspended location within the housing 16 to allow sufficient thermal protection from the housing 16.

In one embodiment, the circuit 72 includes a latching, Hall-effect sensor (illustrated schematically as sensor 72a in FIG. 4) that selectively connects and disconnects electric power from the battery or batteries 66 to the light sources 62 when a sufficient magnetic force is applied to the sensor 72a and the sufficient magnetic force is applicable to the sensor 72a from outside the housing 16. In one embodiment, the magnet used to actuate (i.e., turn off and turn on) the sensor 72a of the circuit 72 is formed as a rare earth magnet (such as from Neodymium), so it has sufficient magnetic strength to be used externally relative to the housing 16. This advantageously allows a user to apply a vacuum within the interior chamber 18 and still be able to turn on and off the power to the light sources 62. Though not shown, a main power switch can also be provided with the circuit 72 to eliminate any parasitic drain of the battery or batteries 66 when not in use.

The camera system 10 can further include a mounting system or assembly 80. In particular, the mounting assembly 80 can include a removable mount 82 for affixing the housing 16 to an associated mounting surface. The mounting assembly 80 can further include an articulating arm 84 interposed between the removable mount 82 and the housing 16 for allowing relative movement of the housing 16 relative to the removable mount 82. In one embodiment, the removable mount 82 is provided with its removability feature by including at least one magnet, such as illustrated magnets 86, for removably affixing the removable mount 82 to the associated mounting surface (i.e., when the associated mounting surface is metallic). In the illustrated embodiment, the removable mount 82 includes a base plate 84 to which the magnets 86 are fixedly secured via fasteners 88.

Also in the illustrated embodiment, the housing 16 is connected to a first end 84a of the articulating arm 84 via a first ball and socket connection 90 and the removable mount 82 is connected to a second end 84b of the articulating arm 84 via a second ball and socket connection 92. The ball and socket connections 90, 92 allow movement of the housing 16 and thus the wireless camera 14 accommodated within the housing 16 for precise alignment of the wireless camera 14. In one embodiment, the magnets 86 are high-temperature magnets allowing for mounting on metal surfaces within high temperature environments as desired. More particularly, in the illustrated embodiment, the articulating arm 84 is formed of two arm members 84c, 84d spaced apart from one another. These are held together via a fastener 94 to capture balls 90a, 92a of the ball and socket joints within apertures 84e, 84f of the arm members 84c, 84d. The balls 90a, 92a are fixedly secured via ball fasteners 96, 98, respectively, to the enclosure 12 and the removable mount 82.

Advantageously, the camera system 10 described hereinabove provides an arrangement whereby the wireless camera 14, the light sources 62, the battery or batteries 66, and the circuit 72 are insulated from heat, such as when the housing 16 is exposed to high temperature environments. In particular, these components are heat insulated from three forms of energy transfer, including conductive, convective, and radiant. In particular, convective heat insulation is provided by the vacuum condition within the interior chamber 18. Radiant heat, such as infrared radiation, is reduced or eliminated by the transparent member 20 and/or the hot mirror 46. Also, the insulating material 48 insulates against radiant heat and conductive heat passed from the external environment through the walls 22, 24 of the housing 16. This provides the camera system 10 in a portable configuration that is able to operate up to temperatures of approximately 450° F. (or 232.2° C.) for a limited time, such as 50 minutes. This enables the camera system to be used in high temperature environments, such as in ovens, bake chambers, or other spaces with elevated temperatures that are generally too hot for humans and/or conventional camera/video equipment to operate. Further advantages are provided since no electrical wires or cooling lines are required to be connected to the camera system 10 when operational for capturing images external to the housing 16.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A portable high temperature camera system, comprising:
a wireless camera;
a housing defining an interior chamber in which the wireless camera is accommodated; and
a transparent member affixed to the housing and arranged to allow the wireless camera to capture images therethrough.

2. The camera system of claim 1 further including:
a hot mirror interposed between the wireless camera and the transparent member, the hot mirror having a reflective surface facing away from wireless camera for reflecting infrared heat.

3. The camera system of claim 1 further including:
an insulating material received within the interior chamber defined by the housing and interposed between the wireless camera and housing for insulating the wireless camera.

4. The camera system of claim 1 wherein the wireless camera is a high definition video camera.

5. The camera system of claim 1 further including:
a vacuum port defined through the housing and fluidly connected to the interior chamber to enable a vacuum to be applied to the interior chamber for insulating the wireless camera.

6. The camera system of claim 5 further including:
a vacuum fitting affixed to the housing and arranged within the vacuum port, the vacuum fitting connectable to an associated vacuum line for applying the vacuum to the interior chamber, the vacuum fitting disconnectable from the associated vacuum line for enabling portability of the housing and maintaining the vacuum within the interior chamber.

7. The camera system of claim 1 further including:
a removable mount for affixing the housing to an associated mounting surface; and
an articulating arm interposed between the removable mount and the housing for allowing relative movement of the housing relative to the removable mount.

8. The camera system of claim 7 wherein the housing is connected to a first end of the articulating arm via a first ball and socket connection and the mount is connected to a second end of the articulating arm via a second ball and socket connection.

9. The camera system of claim 7 wherein the removable mount includes at least one magnet for removably affixing the removable mount to the associated mounting surface.

10. The camera system of claim 1 wherein the housing includes a base wall and at least one body wall extending from the base wall to define the interior chamber, the at least one body wall having a proximal end connected to the base wall and a distal end defining a sight opening opposite the base wall and the proximal end, the housing further including a flange portion extending outwardly from the at least one body wall at or adjacent the distal end thereof, the transparent member secured against the flange portion to close the interior chamber.

11. The camera system of claim 10 further including:
at least one inner seal interposed between the flange portion and an inner side of the transparent member;
a clamp ring fixedly secured to the flange portion to thereby affix the transparent member to the housing; and
at least one outer seal interposed between the clamp ring and an outer side of the transparent member.

12. The camera system of claim 1 further including:
a camera holder disposed within the interior chamber and holding the wireless camera in a suspended position relative to the housing for thermally protecting the wireless camera.

13. The camera system of claim 12 wherein the camera holder includes a light support structure that supports at least one light source externally relative to the wireless camera, a battery holding structure that holds a battery external relative to the wireless camera and a circuit holding structure that holds a circuit electrically connecting the battery to the at least one light source.

14. The camera system of claim 13 wherein the circuit includes a latching, Hall-effect sensor that selectively connects and disconnects electric power from the battery to the at least one light source when a sufficient magnetic force is applied to the sensor and said sufficient magnetic force is applicable to the sensor from outside the housing.

15. A high temperature camera enclosure assembly for a wireless camera, comprising:
a housing defining an interior chamber in which the wireless camera is accommodated; and
a transparent member secured to the housing and arranged to enable the wireless camera to capture images externally relative to the housing.

16. The camera enclosure assembly of claim 15 further including a heat insulating material lining interior walls of the housing that define the interior chamber such that the heat insulating material is interposed between the housing and the wireless camera.

17. The camera enclosure assembly of claim 16 further including a hot mirror disposed on an inner side of the transparent member for reflecting infrared heat away from the wireless camera.

18. The camera enclosure assembly of claim 15 further including a hot mirror disposed on an interior side of the transparent member for reflecting infrared heat away from the wireless camera.

19. A portable high temperature camera enclosure assembly, comprising:
a housing having a wireless camera received therein; and
a transparent member secured to the housing and arranged to enable the wireless camera to capture images externally relative to the housing.

20. The camera enclosure assembly of claim 19 further including:
a camera holder disposed within the housing and holding the wireless camera in suspended relation relative to walls of the housing; and
at least one light source supported by the camera holder and arranged to provide illumination for the wireless camera when capturing the images.
